(19) United States
(12) Patent Application Publication
(10) Pub. No.: US 2007/0070177 A1
(43) Pub. Date: Mar. 29, 2007

(54) Visual and aural perspective management for enhanced interactive video telepresence

(76) Inventor: Dennis G. Christensen, Sacramento, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/479,113

(22) Filed: Jun. 30, 2006

Related U.S. Application Data
(60) Provisional application No. 60/696,051, filed on Jul. 1, 2005.

(51) Int. Cl. H04N 7/14

(52) U.S. Cl. 348/14.01

(57) ABSTRACT

A system and method to establish a sense of physical presence for group teleconferences. The system and method captures video signals of a first group of participants of a teleconference, processes the video signals to eliminate foreshortening and parallax effects, and displays the processed video signals to a second group of participants of the teleconference so that each participant of the first group is displayed in or close to life-size. When a target participant is identified from the first group, the system and method captures video signals of the second group from a location proximate to the position of the video display of the target participant's eyes. The system and method processes the video signals to compensate foreshortening and parallax errors, and displays the processed video signals to the first group so that each participant of the second group is displayed in or close to life-size.

### CROSS REFERENCE TO RELATED APPLICATIONS

This application claims priority under 35 U.S.C. § 119(e) to U.S. Provisional Patent Application Ser. No. 60/696,051, entitled “Visual and Aural Perspective Management for Enhanced Interactive Video Telepresence,” by Dennis Christensen, filed on Jul. 1, 2005, which is hereby incorporated by reference in its entirety.

### FIELD OF INVENTION

The present invention relates generally to the field of electronic communication between human beings, and more specifically to the field of video teleconferencing and the new field of immersive group video telepresence.

### BACKGROUND

Traditionally people communicate with each other through face-to-face (hereinafter called “FTF”) interactions. However, FTF meetings may be an inefficient and costly way to conduct business, particularly when meeting participants (also called “participants”) must travel a great distance. It has been estimated that tens of billion dollars are spent annually by American businesses for travel related expenses. Over the past few years, travel-related costs (lodging, airfare, meals) have increased at a rate frequently greater than that of inflation. In addition, the unproductive time spent in travel cut into profitability several billion dollars more. These reasons, coupled with an uncertain economy and more aggressive foreign competition, have provided a renewed incentive to find ways to lower costs and improve productivity.

Many companies find that teleconferencing may be a solution that is cheaper, faster, and more effective compare to the traditional FTF meetings. A teleconference is a meeting between three or more people located at two or more separate locations connected by some form of electronic communications. A group teleconference is a teleconference between groups of meeting participants (hereinafter called “participants”), each group being located at a separate location.

However, human factors involved in a communication process are very fragile. Even minor deviations from normal FTF meetings or additional constraints and requirements placed on the participants can render a teleconference nearly useless. Therefore, in order to provide participants with results comparable to the results of FTF meetings, the teleconference should provide an interactive experience that is substantially equivalent to that of the FTF meetings. In FTF meetings, all participants are viewed exactly life-size all the time, all participants are visible all the time, and eye contact is possible between any two participants anytime they are looking at each other. These three basic human expectations as a complete package should be present in a group telepresence experience to allow participants to establish a sense of physical presence of the remote participants, allowing them to embrace the use of an electronic substitute for FTF meetings, and thereby achieve results comparable to the results of the FTF meetings.

Existing video teleconferencing solutions have failed to create the conditions for establishing a credible sense of physical presence. Some applications provide life-sized images of meeting participants and a continuous view of all participants present. However, the applications fail to provide eye contact in a group telepresence environment.

Eye contact is an important aspect of FTF communication. It instills trust and fosters an environment of cooperation and partnership. On the other hand, a lack of eye contact between meeting participants can generate feelings of negativity, discomfort, and sometimes even distrust. Because the existing teleconference applications fail to provide eye contact between the participants, they cannot establish a credible simulation of FTF meetings. As a result, user experience and teleconferencing results suffer.

Other applications provide life-sized images of meeting participants and eye contact between two selected participants in different locations. However, these applications do not allow all the participants to view all other participants on a continuous basis (continuous presence). Therefore, when there are multiple participants in each location, which is generally the case in most teleconferences, these applications also fail to establish a credible simulation of FTF meetings and consequently the meeting results suffer.

Accordingly, there is a need for a system and process to provide an interactive experience that is substantially equivalent to that of the FTF meetings in a group teleconference environment.

### SUMMARY

The present invention provides a system and method to establish a sense of physical presence for group teleconferences. In one embodiment of the invention, the system and method captures video signals of a first group of participants of a teleconference, processes the video signals to eliminate foreshortening and parallax effects, and displays the processed video signals to a second group of participants of the teleconference so that each participant of the first group is displayed in or close to life-size. When a target participant is identified from the first group, the system and method captures video signals of the second group from a location proximate to the position of the video display of the target participant's eyes in the location of the second group. The system and method processes the video signals to compensate foreshortening and parallax errors, and displays the processed video signals to the first group so that each participant of the second group is displayed in or close to life-size while maintaining eye contact between the first group and the second group.

One advantage of the present invention is that it can provide group teleconference participants an interactive experience substantially equivalent to that of the FTF meetings. The invention satisfies all three of the basic conditions identified for establishing a sense of physical presence, (1) the target participant and the remote participants can establishes and maintains eye contact, (2) the remote participants are viewed at substantially life-size, and (3) all the remote participants are visible continuously.

Another advantage of the present invention is that it provides more effective and efficient group teleconferences, because the invention can give participants the feeling that they are sitting physically in the same meeting room as the remote meeting attendee. The invention also establishes the spontaneous ability for complex interactive human communication including decision making thereby eliminating the need for costly, time consuming, and dangerous travel. Moreover, moving electrons instead of people enhances companies' productivity, reduces company costs and people stress, and provides a competitive edge over other companies not using this technology.

These features are not the only features of the invention. In view of the drawings, specification, and claims, many additional features and advantages will be apparent.

### BRIEF DESCRIPTION OF THE DRAWINGS

FIG. 1 is a high-level block diagram illustrating the architecture of a video teleconferencing system in accordance with one embodiment of the present invention.

FIG. 2 is a simplified block diagram illustrating the design of two meeting rooms in accordance with one embodiment of the present invention.

FIG. 3 is a simplified front view of the configuration of a video display device and several video cameras in accordance with one embodiment of the present invention.

FIGS. 4(a)-(e) illustrate the foreshortening and parallax effects, the video signals before processing, and the video signals after processing, in accordance with one embodiment of the present invention.

FIG. 5 is a flowchart of an exemplary method to establish eye contact between a target primary participant and remote participants during a teleconference in accordance with one embodiment of the present invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey principles of the invention to those skilled in the art.

Overview of System Architecture

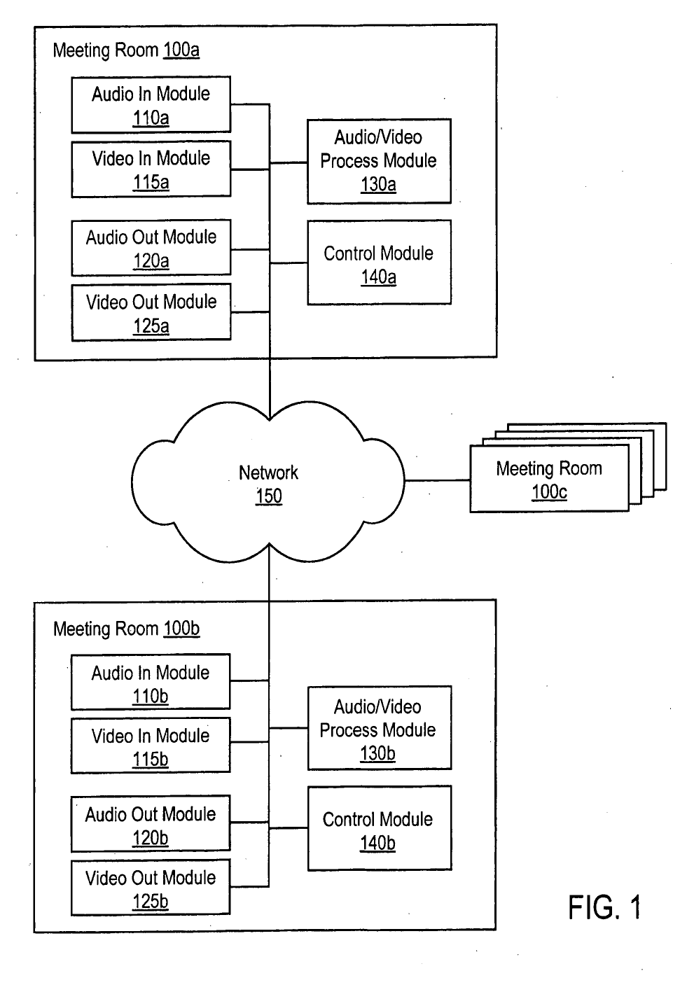

Referring to FIG. 1, there is shown a block diagram illustrating the architecture of a teleconferencing system 100 in accordance with one embodiment of the present invention. In this embodiment, the system 100 includes two meeting rooms 100a and 100b and a network 150. The system 100 can optionally include additional meeting rooms 100c. The meeting rooms 100 are connection through the network 150.

The network 150 is configured to transmit audio, video, and control signals among the meeting rooms 100. The network 150 may be a wired or wireless network. Examples of the network 150 include the public networks, private networks, Internet, an intranet, a cellular network, satellite networks, or a combination thereof, or other system enabling digital and analog communication. In one embodiment, the network 150 includes multiple networks. The audio signals, the video signals, and the control signals all have their own designated network.

Meeting room 100a is configured to include an audio-in module 110a, a video-in module 115a, an audio-out module 120a, a video-out module 125a, optionally an audio/video process module (“A/V process module”) 130a, and optionally a control module 140a. The audio-in module 110a, the video-in module 115a, the audio-out module 120a, the video-out module 125a, the A/V process module 130a, and the control module 140a are communicatively coupled via hardware and/or software to provide access to each other and to the network 150. Similarly, the meeting room 100b includes an audio-in module 110b, a video-in module 115b, an audio-out module 120b, a video-out module 125b, an A/V process module 130b, and a control module 140b. The meeting rooms 100c can be configured similarly.

The video-in module 115a is configured to acquire video signals of teleconference participants located in the meeting room 100a, and transmit the captured video signals to the A/V process module 130a. Each of the teleconference participants can be categorized as a primary participant or a secondary participant. The primary participants are those who are likely to be actively involved in the teleconference, while the secondary participants are the rest of the attendees. Using a regular FTF meeting as an example, the primary participants of one side are those sitting across the meeting table facing the other side, and the secondary participants are those sitting behind the primary participants. The video-in module 115a can be configured to focus on the local primary participants. The video-in module 115a can include one or more video cameras, each of which can be a high quality color television camera, a regular pan, tilt and zoom (hereinafter called “PTZ”) video camera, or other standard video cameras.

In one embodiment, the video-in module 115a includes several video cameras, each associated with a primary participant in a remote meeting room (hereinafter called “remote primary participant”). For example, the video camera can be associated with a primary participant in the meeting room 100b. Each of the video cameras is configured to capture images of the local participants from a location proximate to the position of the video display of the eyes of the associated remote primary participant as being displayed by the video-out module 125a, also known as the apparent position of the eyes of associated remote primary participant.

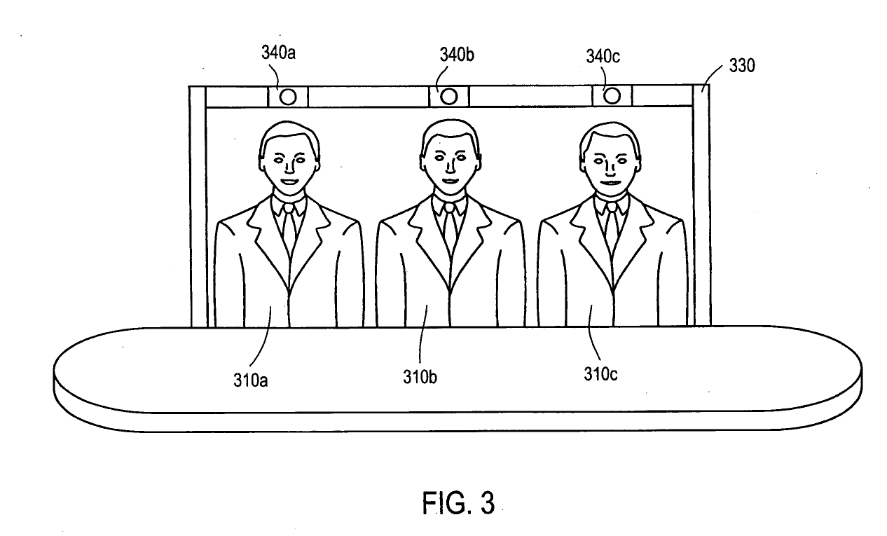

The video cameras can be mounted on top of the video-out module 125, such that they are collocated as closely as possible to the position of the video display of the eyes of the associated remote primary participant. An example of this configuration is illustrated in FIG. 3.

Referring now to FIG. 3, there is shown a configuration of the video-in module and video-out module. The video-in module includes three video cameras 340a, 340b, and 340c. The video-out module includes a large high definition television (HDTV) 330, which displays the image of three remote primary participants 310a, 310b, and 310c. The video cameras 340a-c are embedded in fixed position on the HDTV 330. The video camera 340a is associated with the remote primary participant 310a, the video camera 340b is associated with the remote primary participant 310b, and the video camera 340c is associated with the remote primary participant 310c. Each of the video cameras 340a-c is mounted proximate to the position of the video display of the eyes of the associated remote primary participant 310 as being displayed on the HDTV 330.

Alternatively, the cameras can be positioned behind the video display of the eyes of the associated remote primary participant as being displayed by the video-out module 125a. In one example, the video-out module 125a includes a forward tilted beam-splitter optic, reflecting the image from a flat screen monitor below. The camera is positioned directly behind the beam-splitter optic. In another example, the video-out module 125a includes a front projection screen. The screen is configured to allow light to travel through such that the video camera placed behind the screen can capture images of the local participants sitting in front of the screen. In one example, the screen can be made of acrylic.

The video-in module 115a can associate one video camera or a group of video cameras with a remote primary participant. Because one important factor to an effective teleconference experience is to provide a level of video quality that feels natural to the meeting participants, the video camera(s) preferably can deliver video signals that meet certain picture quality requirements (e.g., VGA resolution or better). The camera(s) associated with a remote primary participant is fitted with a lens or a group of lenses that can produce a field of view wide enough to include the image of all the local participants. The field of view is determined by a number of factors including the number of local participants. For example, in situations where there are three local participants, a single lens with an angle of view of about 55° may be enough, while where there are five local participants, a single lens with an angle of about 85° may be insufficient. Instead of having one camera equipped with one expensive wide angle high resolution lens, the video-in module 115a can have one camera with several inexpensive standard low resolution lenses or several cameras, each equipped with an inexpensive standard lens.

In another embodiment, the video-in module 115a includes one video camera mounted on a sliding track. The control module 140a can command the video camera to slide to a location proximate to the apparent position of the eyes of a remote primary participant, and capture images of the local participants at that location.

The video-in module 115a can determine in advance the approximate position of the video display of the eyes of the remote primary participants as being displayed by the video-out module 125a. For example, the meeting room 100b can fix the meeting chairs on the floor. Because the positions of the video display of the remote primary participants are determined by the fixed location of the chairs they sit on, the positions of the video display of their eyes can also be proximately determined. Therefore, the video cameras can be positioned ahead of time. In one embodiment, the remote primary participants can adjust the height of the chairs, such that they can adjust the vertical position of the video display of their eyes.

Eye contact is one of the most important aspects of FTF communication. It instills trust and fosters an environment of cooperation and partnership. Providing natural feeling eye contact during a teleconference requires that the participants look directly into the camera. Unfortunately, traditional teleconferencing often fails in this regard because the participants have a natural tendency of looking at the video image of the participant who is talking and not at the camera, even if the participants are aware that doing so will fail to establish eye contact to the remote party. By collocating the camera closely to the position of the video display of the eyes of a remote participant (either above or behind the video display), the camera can capture the eye lines of the local participants when the local participants look at the display showing the eyes of the remote participant. The eye line is an imaginary line through which the eyes of a participant are looking. When the video signals captured by the camera are displayed by the video-out module 125b to the remote primary participant, the primary participant would feel an establishment of eye contact when viewing the images of the local primary participants.

The camera needs not to be collocated identically with the video display of the eyes of the remote primary participant. Gaze angle is the angle between the line of the camera and the local primary participant's eyes (camera optical path) and the eye line between the local primary participant and the video display of the remote primary participant's eyes (viewer sight line). Generally the human brain can compensate for limited gaze angles and that meeting participants in such an environment would still experience an acceptable level of eye contact. The system 100 can minimize the gaze angle by controlling the proximity of the camera and the video display of the eyes of the remote primary participants and the distance between the local primary participants and the display of the remote participant. Therefore, by positioning the video camera proximate to the video display of the eyes of the remote primary participant, the system 100 can provide eye contact between the local participants and the remote primary participant.

Referring back to FIG. 1, the audio-in module 110a is configured to acquire sounds generated by the local primary participants (e.g., vocal sounds), convert the captured sound waves into electrical sound signals, and transmit the electrical sound signals to the AN process module 130a. The audio-in module 110a can include one or more microphones, each of which can be a shotgun microphone, a roof-mounted microphone, a unidirectional lavalier microphone, or other directional microphones.

In one embodiment, the microphones can be required to deliver sound signals that meet certain audio quality requirements. By using a directional microphone, the audio capture device can eliminate most of the ambient room noise and echo effects. In addition, the A/V process module 130a can also be configured to further process the sound signals captured by the audio-in module 110a to provide clear and high fidelity sound signals of the local primary participants to the remote participants.

In one embodiment, the audio-in module 110a includes several microphones, each associated with a local primary participant. Each microphone is configured to capture sounds generated by the associated local primary participant. The microphone can be mounted on a meeting table, a chair, or other equipments proximate to the associated local primary participant. Alternatively, the microphone can be embedded in the ceiling or be clipped on the associated primary participant's clothes. The audio-in module 110a can associate multiple microphones to a local primary participant. Each microphone can be positioned toward its associated local primary participants such that when a local primary participant is talking, the associated microphone(s) would be able to receive the vocal signals, thereby enabling the AN process module 130a to identify which local primary participant is speaking.

The video-out module 125a is configured to display the video signals captured by a video-in module 115 from a remote conference room 100, such as the video-in module 115b in the remote conference room 100b. The video-out module 125a can include one or more video display devices, each of which can be a liquid crystal display (“LCD”), a cathode ray tube (“CRT”), a plasma display (“PDP”), digital light processing (“DLP”) video projectors, and other types of video display devices.

Because an effective teleconference experience includes video of remote participants that feels natural to the meeting participants, the video display device can be required to display images of the remote participants that meet certain picture quality requirements such as video resolution. Video resolution is the amount of information captured and displayed on the screen and it is usually measured in the number of horizontal or vertical picture elements (or pixels). Higher resolution yields a more “natural” feeling for meeting participants because higher resolution yields images of higher clarity. In order to display quality images of the remote participants in sufficient resolution, the video-out module 125a can include one large high-definition video display device (e.g., 72″ HDTV). Alternatively, the video-out module 125a can have several inexpensive standard low resolution video display devices (e.g., 32″ by 24″ regular TV positioned in a portrait format), each designated to display the substantially life-size image of one remote participant.

In one embodiment, the video-out module 125a can display full image of the remote participants. By displaying the full images of the remote participants, local participants can perceive both verbal language and body language from the remote meeting participants.

In one embodiment, the video-out module 125a can display the images of the remote participants in substantially life-size. In order for the local participants to perceive the remote participants as live persons sitting directly across the meeting table, the video-out module 125 displays the images of the remote primary participants in substantially life-size, in true-to-life color and at seated eye level. The video-out module 125a should provide sufficient display space for the substantially life-size images of the remote participants. For example, to display three remote participants, video-out module 125a can include either three 40″ diagonal 4:3 standard televisions, or one 85″ diagonal 16:9 widescreen HDTV. To display six participants in life-size, the video-out module 125a can use six standard televisions or one 144″ by 36″ high resolution video display device.

Alternatively, the video-out module 125a can include video display devices with smaller (or bigger) display space and display the images of the remote participants proportionally smaller (or bigger). The video-out module 125a can also display the images of the remote participants in a single color (e.g., monochrome) or multiple colors. The video-out module 125a can also be configured to display the video images of the remote participants in full motion (e.g., 24 frames per second or greater).

The video display devices can be mounted on a wall or in a chair behind a meeting table facing the local participants. In the example illustrated in FIG. 3, the video-out module 125a includes one large HDTV mounted on one side of the meeting table. When the video-out module 125a includes multiple video display devices, each displaying the image of one remote participant, the video display devices can be placed apart, with the space in between reflecting the space between the remote participants. The video display devices can be positioned in a portrait format at a height that enables the local participants see the remote participants at seated eye level.

The audio-out module 120a is configured to convert the received electrical sound signals into sound waves loud enough to be heard by local meeting participants. The audio-out module 120a can include one or more speakers. The speakers can be required to deliver quality sound that meets certain sound quality requirements.

In one embodiment, the audio-out module 120a includes several speakers, each associated with a remote primary participant. Each speaker is configured to reproduce the sounds generated by the associated remote primary participant. The speakers can be positioned to reproduce the sounds from a location proximate to the apparent position of the mouth of the associated remote primary participant.

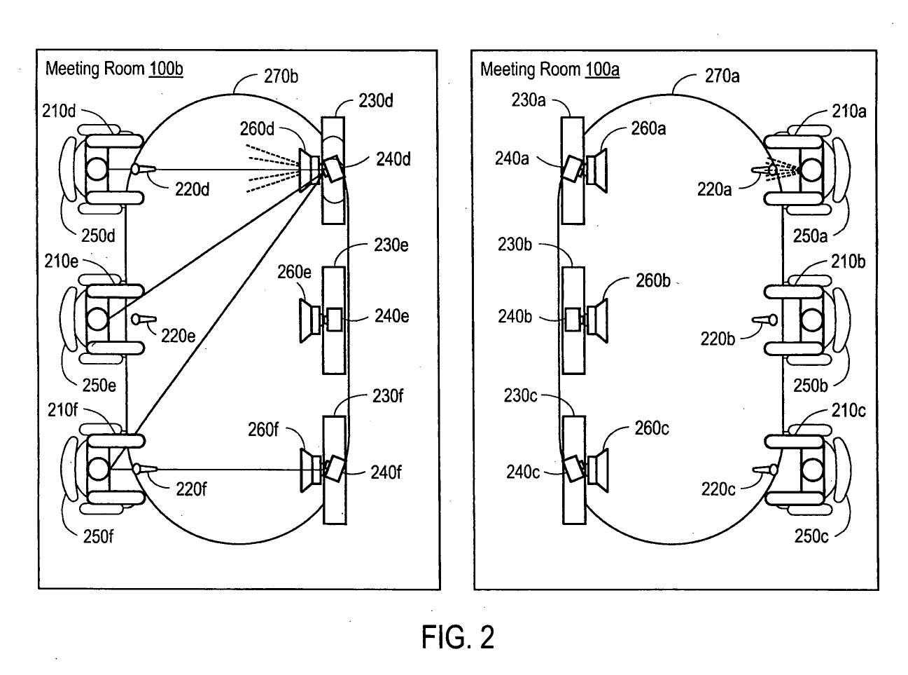

Referring now to FIG. 2, there is a block diagram illustrating the design of two meeting rooms 100a and 100b in accordance with one embodiment of the present invention. The meeting room 100a includes a conference table 270a, three video display devices 230a-c, three video cameras 240a-c, three speakers 260a-c, three microphones 220a-c, three chairs 250a-c, and three primary participants 210a-c. Similarly, the meeting room 100b includes a conference table 270b, three video display devices 230d-f, three video cameras 240d-f, three speakers 260d-f, three microphones 220d-f, three chairs 250d-f, and three participants 210d-f.

The audio-in module 110 as illustrated in FIG. 2 includes the microphones 220 mounted on the meeting tables 270. Each microphone 220 is associated with one local primary participant 210. For example, the microphone 220a is associated with the primary participant 210a, and so on. Each microphone 220 is positioned towards and close to the associated primary participant 210 such that any vocal sound made by a primary participant 210 will be detected by the associated microphone 220. The primary participant 210a is shown to be speaking. The associated microphone 220a acquires the sounds and converts into electrical sound signals. In alternate embodiments, fewer microphones 220 can be used. For example, the audio-in module 110 can simply include one wireless microphone that can be passed among the local participants 210.

The audio-out module 120 includes the speakers 260 mounted on the video display devices 230. Each speaker 260 is associated with one remote primary participant 210. For example, the speaker 260d is associated with the primary participant 210a, the speaker 260a is associated with the primary participant 210d, and so on. Each speaker 260 is positioned close to the video display of the associated primary participant 210. For example, the speaker 260d is positioned close to the video display of the associated primary participant 210a. Each speaker 260 is also positioned towards the primary participants 210 in the same meeting room 100 as the speaker 260. For example, the speaker 260d faces the primary participants 210d-f. Each speaker 260 reproduces the sound acquired by the microphone 220 from the associated primary participant. For example, the primary participant 210a is shown to be speaking. The sound is acquired by the microphone 220a, and reproduced by the speaker 260d. As a result, the sound appears to the local participants 210d-f to be from the video display of the remote primary participant 210a, the one who is speaking. The local participants 210d-f can have an aural perception that the remote participant 210a is sitting across the meeting table 270b. In alternate embodiments fewer speakers 260 can be used. For example, the audio-out module 120 can simply include one center-located speaker.

The video-in module 115 includes the video cameras 240 mounted on top of the video display devices 230. Each video camera 240 is associated with one remote primary participant 210. For example, the video camera 240d is associated with the primary participant 210a, and so on. Each video camera 240 is positioned proximate to the position of the video display of the eyes of the associated primary participant 210 as being displayed on the video display devices 230. For example, the video camera 240d is mounted on top of the video display device 230d, right above the video display of the head of the associated primary participant 210a, and proximate to the video display of the primary participant 210a's eyes. As a result, when the local participants 210 look into the video display of a remote participant 210's eyes, the video camera associated with the remote participant can capture the eye lines of the local participants.

The video-out module 125 includes the video display devices 230 mounted on the meeting tables 270. Each video display device 230 is associated with a remote primary participant 210. For example, the video display device 230d is associated with the primary participant 210a, and so on. Each video display device 230 displays the image of the associated remote primary participant 210 in substantially life-size, true-to-life color and at seated eye level in full motion video. As a result, the local participants 210 can have a visual perception that the remote participants 210 are sitting across the meeting table 270.

In one embodiment, the chairs 250 can be fixed to the meeting room floor. As a result, the position of the primary participants 210 can be determined before the teleconference meeting, and the microphones 220, the speakers 260, the video cameras 240, and the video display devices 230 can be positioned ahead of time with regard to the position of the associated participants 210.

Referring now back to FIG. 1, the control module 140a is configured to control the modules 110a, 115a, 120a, and 125a, and coordinate with remote control modules 140, such as the control module 140b, to establish a sense of physical presence of the remote participants to the local participants. In some embodiments, the control module 140a does not need to be located in the meeting room 100a. For example, the control module 140a can be remotely located in a central office and controls the meeting rooms 100a-c. The control module 140a and 140b can be running on the same computer or functionally combined into one control module.

The control module 140 can be configured to control the audio-in module 110 and identify the source of the sound signals acquired by the audio-in module 110. One example is illustrated in FIG. 2. Referring now to FIG. 2, the primary participant 210a is speaking. The associated microphone 220a acquires the vocal sound of the participant 210a and converts into electrical signals. The control module 140a identifies the source of the sound signals to be the primary participant 210a, and transmits control signals to the remote control module 140b, informing it so. After identifying the source of the sound signals, the control module 140a can optionally stops the other microphones 220b and 220c from sending signals to the A/V process module 130a.

The control module 140 can be configured to control the video-in module 115 to establish eye contact between the local participants and the remote participants. One example is illustrated in FIG. 2. Referring now to FIG. 2, the primary participant 210a is speaking. The control module 140b receives control signals from the remote control module 140a, indicating that the primary participant 210a is speaking. Consequently, the control module 140b commands (or switches) the video camera 240d, the video camera that is associated with the remote primary participant 210a, to acquire video and transmit to the A/V process module 130b. Because the video camera 240d acquires video signals in a location proximate to the apparent location of the primary participant's 210a eyes, and the participants 210d-fhave a natural tendency to look into the speaker's eyes, the video camera 240d can capture the eye lines of the participants 210d-f. As a result, when the video of the participants 210d-f captured by the video camera 240d is displayed on the video display devices 230a-c to the participants 210a-c, the participants 210d-f appears to be looking at the participants 210a-c, thereby establishing and maintaining eye contact between the participants 210a-c and 210d-f. After receiving the command signals from the control module 140a, the control module 140b can optionally prevent the other video cameras (240e, 240f) from sending signals to the A/V process module 130b.

Instead of detecting the speaking participant, the control module 140 can identify an active participant through other means. For example, one of the local primary participants (e.g., the team leader) can be preselected as the active participant. Alternatively, the control module 140 can identify the local primary participant with active arm movement (e.g., communicating in sign language) to be the active participant, and transmit control signals to the remote control module 140 so that the video camera associated with the active participant can acquire video of the remote participants.

The control module 140 can be configured to synchronize the audio and video of the teleconference, so that the sound of a remote primary participant is reproduced by the speaker associated with that participant. An example of this synchronization is illustrated in FIG. 2. Referring now to FIG. 2, the participant 210a is speaking. The associated microphone 220a acquires the vocal sound of the participant 210a, converts into electrical signals, and transmits to the AN process module 130a. The control module 140b receives control signals from the control module 140a, indicating that the electronic signals of the sound is from the primary participant 210a. Consequently, the control module 140b commands the speaker 260d, the speaker that is associated with the remote primary participant 210a to convert the electronic signals back to sound waves and reproduce it to the local participants 210d-f. Because the speaker 260d is proximate to the apparent position of the remote primary participant 210a, the audio and video of the primary participant 210a is synchronized. As a result, the local participants 210d-f can have a consistent aural and visual perception that the remote participant 210a is sitting across the meeting table 270b.

The control module 140 can be configured to do voice activated switching (VAS) such that the process to establish eye contact and the synchronization process described above are activated by voice detection. When another participant 210 starts speaking, the control module 140 automatically activates the corresponding microphone 220, speaker 260, and video camera 240. As a result, the teleconference participants continuously experience a sense of physical presence of the remote participants, which includes video display of remote participants in substantially life-size, true-to-life color and at seated eye level, the synchronized audio and video of the remote participants, and eye contact between the local participants and the remote participants. Alternatively, instead of a full VAS system, the system 100 can be configured to enable meeting participants to selectively activate a local and/or remote camera 260 through means such as pushing a button.

The control module 140 can be configured to control the position of the video out module 125. For example, the video display devices of the video out module 125 can be mounted on rotatable chairs. When one participant starts speaking, the control module 140 can rotate the chairs holding the video display devices, such that the video display devices are biased to the direction of the speaking participant. As a result, the speaking participant feels that the remote participants turn to face him as he starts talking, just as participants in a FTF meeting would do, enhancing his sense of physical presence of the remote participants.

The control module 140 can be configured to provide the meeting participants with additional controls. For example, the control module 140 can provide the participants with a control interface (e.g., a computer monitor and a keyboard, a remote control) through which the participants can adjust the video-out module 125 (e.g., size, position, brightness), the video-in module 115 (e.g., pan, tilt, zoom, and focus), the audio-out module 120 (e.g., volume, direction), the audio-in module 110 (e.g., position, sensitivity). The control module 140 can also allow the local participants to choose the other meeting room 100 to establish or initiate a teleconference or request online technical support. The control module 140 can also provide more sophisticated features and control for an experienced user during a meeting if desired, including manual overriding all automatic functions, and recording the teleconference.

Referring now back to FIG. 1, the A/V process module 130a is configured to process the signals received from the audio-in module 110a and the video-in module 115a, and coordinate with remote AN process modules 130, such as the A/V process module 130b, to provide audio and video signals sufficient to establish a sense of physical presence of the remote participants to the local participants. Similar to the control module 140a, the A/V process module 130a does not need to be located in the meeting room 100a and can be functionally combined with other A/V process modules 130 into one A/V process module 130.

The A/V process module 130 can be configured to provide substantial life-size image of the meeting participants by conducting digital image processing to the video signal received from the video-in module 115. Such digital image processing includes eliminating visual effects such as foreshortening and parallax.

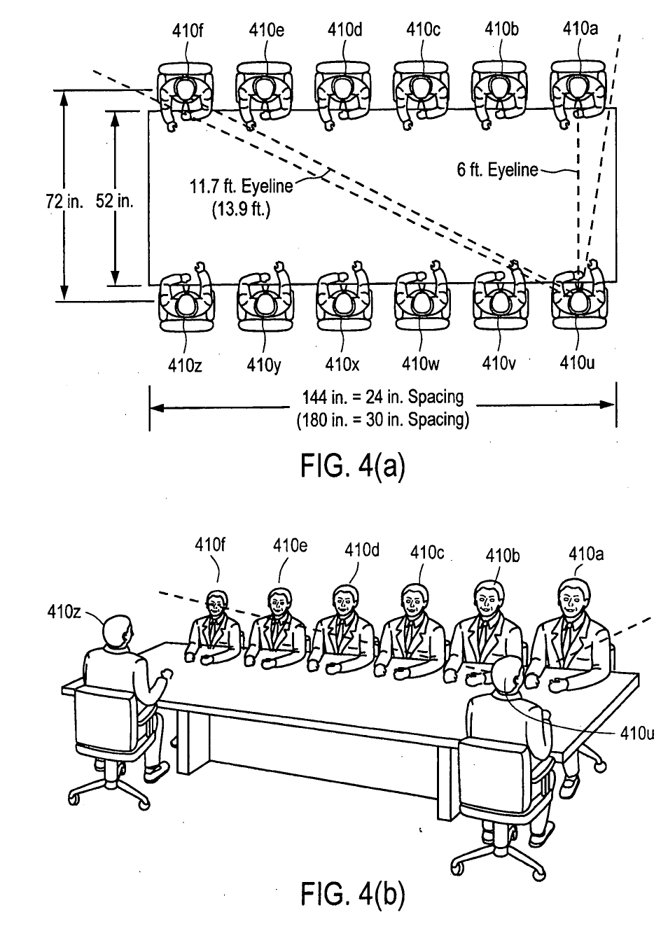

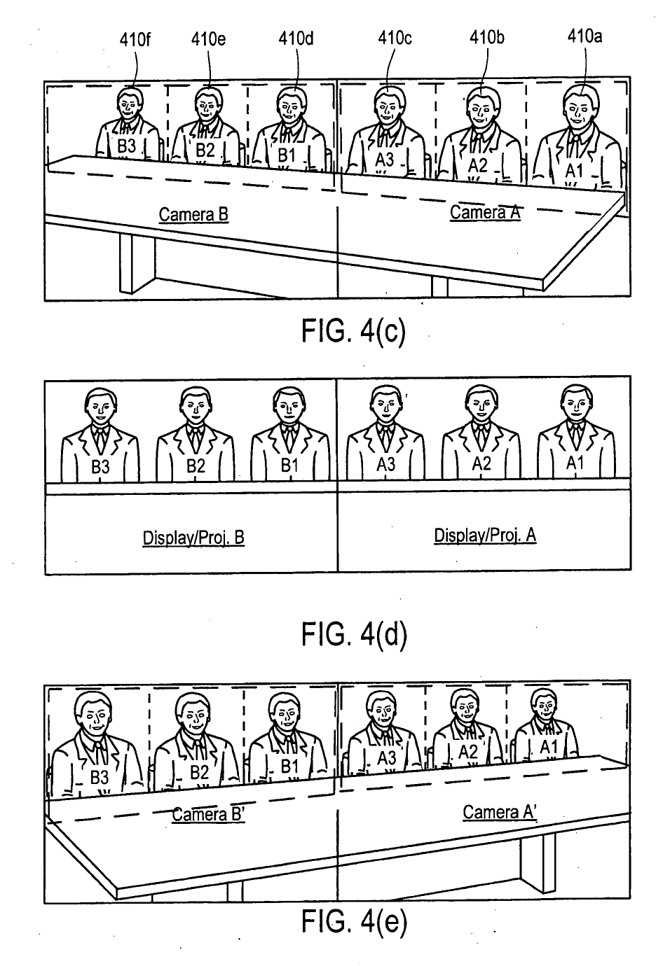

Foreshortening is the visual effect of objects appearing smaller and distorted as their distance from the observer increases. Parallax is the visual effect of objects appearing closer together as their distance from observer increases. One example of the foreshortening and parallax effects is illustrated in FIGS. 4(a)-(e). Referring now to FIG. 4(a), there is shown a top down view of a group meeting. Six participants 410a-f sit across a meeting table from six other participants 410u-z. Potential eye lines of the participant 410u are displayed in dashed lines. The eye-to-eye distance between the participant 410u and the participant 410a, the closest participant sitting across the meeting table, is approximately 6 feet long. The eye-to-eye distance between the participant 410u and the other participants sitting across the meeting table increases as their distance to the participant 410a increases, with the eye-to-eye distance between the participant 410u and the participant 410f, the participant sitting furthest away from the participant 410a, being approximately 11.7 feet long.

Referring now to FIG. 4(b), there is shown the image of the participants 410a-f as perceived by the participant 410u. Because the eye-to-eye distances between the participant 410u and the participants across the meeting table vary, the image is subject to the foreshortening and parallax effects. In the image the participant 410a appears biggest, and the sizes of the participants 410a-f decrease as the participants 410a-f sit further away from the participant 410u, with the participant 410f appearing the smallest. These varying sizes of the participants 410a-f are the result of the foreshortening effect. It is also noted that the participant 410a and 410b appears sitting most distant from each other, and the spaces between the neighboring participants decrease as the participants sit further away from the participant 410u, with the participants 410e and 410f sitting the closest together. These varying spaces between the neighboring participants 410a-f are the result of the parallax effect.

Assuming two video cameras Cam A and Cam B are placed proximate to the position of the eyes of the participant 410u, the combined image of the participants 410a-f acquired by the video cameras can be as illustrated in FIG. 4(c). The combined image has similar foreshortening and parallax effects as the participant 410u would have perceived. To identify the participants more clearly, the participants 410a-f are also labeled as A1 (410a), A2 (410b), A3 (410c), B1 (410d), B2 (410e), and B3 (410f), with images of participants A1-3 being taken by the video camera Cam A and images of participants B1-3 being taken by the video camera Cam B.

Assuming two additional video cameras Cam A′ and Cam B′ are placed proximate to the position of the eyes of the participant 410z, the combined image of the participants 410a-f would be as illustrated in FIG. 4(e). The foreshortening and parallax effects are different compare to those shown in FIG. 4(c), even though the participants are the same. In FIG. 4(e) the video cameras Cam A′ and B′ are positioned closest to the participant B3, therefore the participant B3 appears the biggest and is most distant from the neighboring participant, whereas the participant A1 appears the smallest and is the closest to the neighboring participant.

Displaying the video with the foreshortening and parallax effects is disadvantageous for several reasons. First, the meeting participants cannot be displayed in substantially life-size. Because of the foreshortening effect, the sizes of the images of the remote participants 410 decrease as the corresponding remote participants 410 sit further away from the video camera. As a result, the size of the images of the remote participants varies, and cannot be life-size. As discussed earlier, failure to display remote participants in substantially life-size weakens the local participant's sense of physical presence of the remote participants, and consequently the user experience will suffer.

Second, switching from displaying video captured by one video camera to displaying video captured by a differently located video camera disrupts meeting participants' experience. Because the foreshortening effect, the size and shape of the image of a remote participant is determined by the distance between the participant and the video camera. As a result, the images of the same remote participant vary as the locations of the video cameras taking the images vary. For example, the participant A1 appears the biggest among all the remote participants as illustrated in FIG. 4(c), and appears the smallest as illustrated in FIG. 4(e). Similarly, because of the parallax effect, the distances between the neighboring participants also vary as the locations of the video cameras vary. Therefore, as the teleconference proceeds, the local participants would observe the images of the remote participants to dynamically change sizes and shift positions as the speaker changes and the video-out module 125 switches among video taken by differently located video cameras. This significant and disturbing image sizing and positioning error is inconsistent with the sense of physical presence of the remote participants as described above.

Third, as described above, the parallax effect causes the images of remote participants to shift position. This shift in position causes the apparent location of the remote participants' eyes to change, which in turn causes the video cameras to be displaced away from the apparent location of the associated remote participants' eyes. As a result, the local cameras can no longer capture the eye lines of the local participants, and the system 100 can no longer establish eye contact between the participants.

In order to eliminate the foreshortening and parallax effects, the A/V process module 130 conducts digital image processing on the images. The digital image processing includes graphical operations such as resizing, repositioning, and rotating. Because in one embodiment the chairs for the participants are fixed to the floor, the locations of the participants are determinable. Because the video cameras are positioned to be proximate to the apparent locations of the primary participants' eyes, the locations of the video cameras are also determinable. Therefore, the A/V process module 130 can determine the distances between each of the local participants and each of the video cameras. As a result, the A/V process module 130 can calculate the ratio of compensation for the images of each of the participants taken by each of the video cameras and for the distances between the neighboring participants in the images, and compensate the images according to the ratios to eliminate the foreshortening and parallax effects.

One example of the processed image is illustrated in FIG. 4(d). Referring now to Fig. 4(d), there is shown a processed image of the participants A1-3 and B1-3 as being displayed by the video-out module 125. The image is substantially free of foreshortening and parallax effects. The participants A1-3 and B1-3 are all displayed in substantially life-size, and the distances between the participants can reflect the actual distances between them. As a result, when the video-out module 125 switches from displaying video taken by one video camera to displaying video taken by a differently located video camera, the images of the participants A1-3 and B1-3 would be substantially the same, with no change in size, no shift in space.

Alternatively, instead of using digital video processing to eliminate the foreshortening and parallax effects, the system 100 can compensate the images using optical means. For example, the system 100 can equip the video cameras with multiple lenses, each associated with a primary participant. Each lens can be configured to optically compensate the image of the associated primary participant such that the images acquired by the video camera are free of foreshortening and parallax effects.

After processing the video received from the video-in module 115, the A/V process module 130 transmits the processed video to the remote A/V process module 130 associated with the meeting room 100 where the video is intended to be displayed. The remote A/V process module 130 can resize the received video based on the configuration of the associated video-out module 125 so that the images of the meeting participants would be displayed in substantially life-size. Subsequently, the remote A/V process module 130 transmits the resized video to the video-out module 125 to be displayed to local participants.

When switching from video taken by a first video camera to video taken by a second video camera, the A/V process module 130 can mix video frames to provide a smooth transfer to the viewers. For example, the AN process module 130 can insert 10 frames of pre-selected video transition. Alternatively, the A/V process module 130 can insert video captured by video cameras located between the first and second video cameras or provide other transition techniques such as fading or morphing between images. As a result, the video appears to be taken by a single video camera, and the audience of the video can hardly notice the switch from one camera's video signals to the next camera's video signals.

As discussed previously, the video cameras can be configured for voice activated switching (VAS). Therefore, when a primary participant sitting at one end of the meeting table starts talking, the video camera(s) associated with the speaker in the remote meeting room captures the images of the remote participants. When another primary participant sitting at the other end of the meeting table starts talking, the video camera(s) associated with the new speaker starts taking video signals, and the local participants start viewing video taken by the video camera(s) associated with the new speaker. By eliminating the foreshortening and parallax effects, the system 100 can provide a stable, viewable, substantially life-size image of all remote participants which retains the eye contact continuously.

The A/V process module 130 can also be configured to process the audio signals received from the audio-in module 110 to provide clear and high fidelity sound signals of the meeting participants. For example, the processing can eliminate the ambient room noises and echo effects.

The A/V process module 130 can be configured to conduct digital audio and video compression, such that the compressed audio and video signal takes less network bandwidth when being transferred over the network 150, and when decompressed by the remote A/V process module 130, the decompressed audio and video signal still can provide a level of quality that feels natural to the meeting participants.

In another embodiment, the A/V process module 130 removes the background of the meeting room from the video before transmitting the video to the intended remote A/V process module 130. For example, the background of the meeting rooms 100 can be painted blue (or green) for easy removal by the A/V process module 130. The intended remote A/V process module 130 can optionally add the local meeting room as background. This feature can further enhance the meeting participants' sense of physical presence of the remote participants. By removing the background of the remote meeting room, the A/V process module 130 eliminates the foreshortening and parallax effects of the background.

One skilled in the art will recognize that the system architecture illustrated in FIG. 1 is merely exemplary, and that the invention may be practiced and implemented using many other architectures and environments.

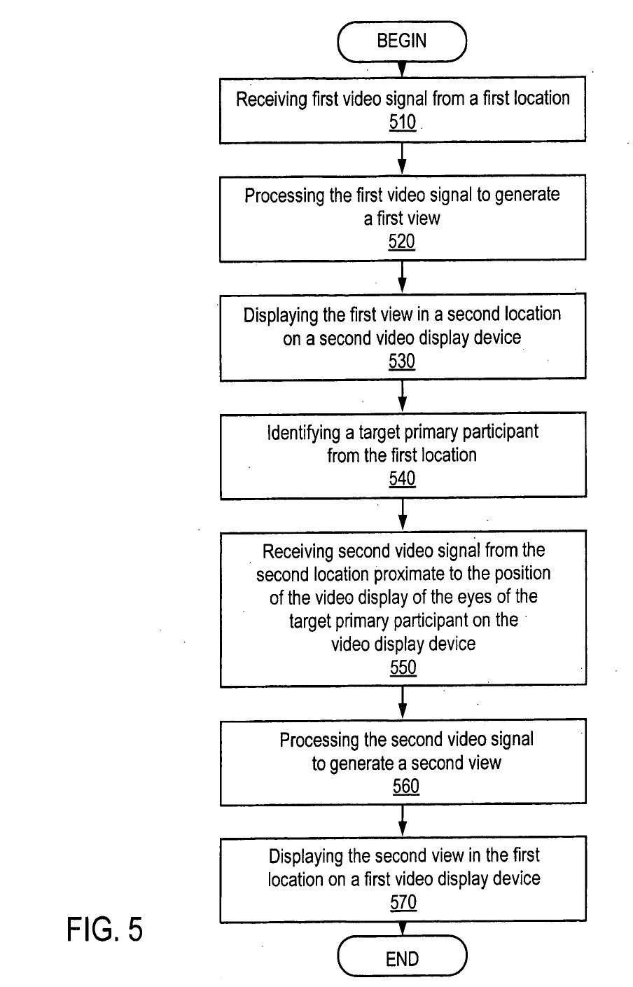

The principles described herein can be further described through an example of a group teleconference. Referring now to FIG. 5, there is shown a flow diagram depicting a method for establishing and maintaining a sense of physical presence of remote teleconference participants during a group teleconference meeting. The steps of the process illustrated in FIG. 5 may be implemented in software, hardware, or a combination of hardware and software.

In one embodiment, the steps of FIG. 5 may be performed by one or more components of the architecture shown in FIG. 1, although one skilled in the art will recognize that the method could be performed by systems having different architectures as well.

The flowchart shown in FIG. 5 will now be described in detail, with reference to the example of a group teleconference illustrated in FIG. 2. The process commences with a group teleconference between a first group of participants in a first location and a second group of participants in a second location. Both locations are configured similarly to a meeting room 100. For example, as illustrated in FIG. 2, the group teleconference can be between the first group of participants 210a-c in the meeting room 100a and the second group of participants 210d-f in the meeting room 100b.

With reference to FIG. 5, the video-in module 115 receives 510 a first video signal from the first location. The received first video signal includes the images of each teleconference participant in the first location. The first video signal can be captured by a video camera located proximate to the position of the video display of the eyes of a participant from the second group on a local video display device in the first location. The first video signal is then transmitted to the A/V process module 130 that can be local to the first location. The audio-in module 110 can also transmits the received audio signal to the same A/V process module 130. In the example illustrated in FIG. 2, the video camera 240c captures the first video signal of the participants 210a-c and transmits to the control module 140a (not shown). The microphones 220a-c can also transmit audio signal received from the meeting room 100a to the control module 140a.

With reference to FIG. 5, the A/V process module 130 processes 520 the first video signal to generate a first view. The process 520 is configured to eliminate any foreshortening and parallax effects from the first video signal. Optionally the process 520 can also be configured to compress the first view. After generating the first view, the A/V process module 130 can transmit it to A/V process module 130 of the second location, which can decompress the first view, resize it so that the images of the first group of participants can be displayed in substantially life-size in the local video-out module 125, and transmits the resized first view to the video-out module 125.

The processing 520 can be optional if the video-in module 115 uses other means to eliminate the foreshortening and parallax effects, such as installing lenses that optically compensate the video signals.

In the example illustrated in FIG. 2, the A/V process module 130a processes 520 the first video signal to generate the first view. As a result, the first view has substantially no foreshortening or parallax effect. Therefore, images of the participants 210a-c are in substantially equal size, and the distances between the neighboring participants can reflect the actual distances between the participants. The A/V process module 130a compresses the first view and transmits it through the network 150 to the A/V process module 130b. The A/V process module 130b decompresses the first view, resizes it based on the configuration of the video display devices 230d-f, partitions the resized first view into three sub-views, each containing the image of a remote primary participant 210, and transmits the sub-views to their associated video display devices 230d-f.

With reference to FIG. 5, the video-out module 125 displays 530 the first view in the second location on a second video display device. The first view being displayed is substantially free from foreshortening and parallax effects and the images of the first group of participants are displayed in substantially life-size, true-to-life color, full motion video. The video-out module 125 can display the first view in one or more video display devices. The audio-out module 120 can reproduce the audio signals received.

In the example illustrated in FIG. 2, the video display device 230d displays the substantially life-size, true-to-life color, video signals of the remote participant 210a. Similarly, the video display devices 230e and 230f display the video of the participants 210b and 210c.

With reference to FIG. 5, the control module 140 local to the first location identifies 540 a target primary participant from the first group in the first location. In one example, the target primary participant is the speaking primary participant. For example, the control module 140 can identify 540 the speaking participant by processing the audio signals received from the audio-in module 110. The control module 140 then transmits a control signal via the network 150 to the control module 140 of the second location identifying the target primary participant. The control module 140 also transmits the audio signals of the target primary participant to the control module 140 of the second location.

In the example illustrated in FIG. 2, the control module 140a receives the vocal signal of the participant 210a captured by the microphone 220a and identifies the primary participant 210a as the target primary participant. The control module 140a then transmits control signals to the control module 140b, indicating that the participant 210a is the target primary participant. The control module 140a also transmits the vocal signal of the participant 210a to the control module 140b.

With reference to FIG. 5, the control module 140 of the second location identifies the video camera associated with the target primary participant, and commands the video camera to capture the second video signal receive 550 proximate to the position of the video display of the eyes of the target primary participant on the second video display device. The control module 140 can also reproduce the audio signals of the target primary participant in a speaker proximate to the apparent position of the target primary participant's mouth. Because the participants have a natural tendency of looking at the video display of the eyes of the current speaker, the received second video signal captures the eye lines of the second group of participants in the second location. There can be more than one video camera associated with the target primary participant. Alternatively, the control module 140 can command a video camera mounted on a sliding track to move to a position proximate to the apparent position of the target primary participant's eyes and receive 550 the second video signal. The second video signal is then transmitted to the A/V process module 130 local to the second location.

In the example illustrated in FIG. 2, the control module 140b commands the video camera 240d to capture the second video signals of the local participants 210d-f. The control module 140b also commands the speaker 260d to reproduce the vocal signal captured by the microphone 220a. Because the local participants 210d-f has a natural tendency to look at the video display of the speaking participant, in this case the participant 210a, the video camera 240d can capture the eye lines of the participants 210d-f. The second video signal is then transmitted to the A/V process module 130b (not shown).

With reference to FIG. 5, the A/V process module 130 local to the second location processes 560 the second video signal to generate a second view. The process 560, similar to process 520, is configured to substantially eliminate foreshortening and parallax effects from the second video signal. After generating the second view, the A/V process module 130 can transmit the second view to the A/V process module 130 of the first location, which resizes the second view so that the images of the second group of participants can be displayed in substantially life-size, and transmits the resized second view to the video-out module 125.

In the example illustrated in FIG. 2, the A/V process module 130b processes 560 the second video signal to generate the second view. Similar to the first view, the second view is substantially free from foreshortening or parallax effects. Therefore, images of the participants 210d-f are in substantially equal size and the distances between the neighboring participants reflect the actual distances between them. The A/V process module 130b transmits the second view to the A/V process module 130a. The A/V process module 130a resizes the second view based on the configuration of the video display devices 230a-c, partitions the second view into three sub-views, each containing the image of a remote primary participant 210, and transmits the sub-views to their associated video display devices 230a-c.

With reference to FIG. 5, the video-out module 125 displays 570 the second view in the first location on a video display device. The second view being displayed is substantially free from foreshortening or parallax effects and the images of the second group of participants are displayed in substantially life-size, true-to-life color, full motion video. Because the second video signal captures the eye lines of the second group of participants, the second group of participants appears to look at the first group of participants. Therefore, the system 100 establishes eye contact between the first and second groups of participants.

In the example illustrated in FIG. 2, the video display device 230a displays the substantially life-size, true-to-life color, full motion video of the remote participant 210d. Similarly, the video display devices 230b and 230c display the video of the participants 210e and 210f. Because the second view captures the eye lines of the remote participants 210d-f, the video display of the remote participants 210d-f appears to be looking at the local participants 210a-c. As a result, the system 100 establishes and maintains eye contact between the participants 210a-c and the participants 210d-f, even though they are located in different meeting rooms 100a and 100b.

After the video-out module 125 displays 570 the second view, the system 100 can repeat the steps 540-570 to establish and maintain eye contact of the first and second groups of participants and provide substantially life-size, true-to-life color, full motion video of the remote participants. As a result, the teleconference participants can have a sense of physical presence of the remote participants and achieve desirable results substantially equivalent to that of the FTF meetings.

The language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method to establish a teleconference between a first group of participants in a first location and a second group of participants in a second location, the method comprising:
receiving first video signals of the first group, the first video signals comprising a video display of the eyes of the participants in the first group;
displaying the first video signals to the second group;
identifying a target participant from the first group, the target participant changes during the teleconference;
receiving second video signals of the second group, the second video signals being received at a position substantially proximate to the position of the video display of the eyes of the target participant as being displayed to the second group, the second video signals comprising a video display of the eyes of the participants in the second group; and
displaying the second video signals to the first group.

2. The method of claim 1, wherein displaying the first video signals comprises:
processing the first video signals to generate a first view, the first view comprising substantially life-size images of participants in the first group; and
displaying the first view to the second group;
wherein displaying the second video signals comprises:
processing the second video signals to generate a second view, the second view comprising substantially life-size images of participants in the second group; and
displaying the second view to the first group.

3. The method of claim 2, wherein the processing of the first video signals comprises one or more of: resizing, repositioning, and rotating the first video signals.

4. The method of claim 1, wherein displaying the first video signals comprising:
processing the first video signals to generate a first view comprising images of participants in the first group, wherein the first view is substantially free from foreshortening and parallax effects, wherein the processing includes one or more of: resizing, repositioning, and rotating the first video signals; and
displaying the first view to the second group.

5. The method of claim 1, further comprising:
receiving audio signals of the first group;
wherein identifying a target participant comprises identifying the target participant from the first group based on the audio signals.

6. The method of claim 1, wherein the target participant is the speaking participant.

7. A method to establish a teleconference between a first group of participants and a second group of participants, the method comprising:
receiving first video signals of the first group;
processing the first video signals to generate a first view comprising images of participants in the first group, wherein the first view is substantially free from foreshortening and parallax effects, wherein the processing includes one or more of: resizing, repositioning, and rotating the first video signals; and
displaying the first view to the second group.

8. The method of claim 7, wherein the first view comprising substantially life-size images of participants in the first group.

9. A teleconference system for establishing a teleconference between a first group of participants in a first location and a second group of participants in a second location, the system comprising:
a video-out module in the second location for displaying first video signals of the first group to the second group, the first video signals comprising a video display of the eyes of the participants in the first group;
a control module for identifying a target participant from the first group, the target participant changes during the teleconference;
a video-in module in the second location for receiving second video signals of the second group, the second video signals being received at a position substantially proximate to the position of the video display of the eyes of the target participant as being displayed by the video-out module to the second group, the second video signals comprising a video display of the eyes of the participants in the second group; and
a video-out module in the first location for displaying the second video signals to the first group.

10. The system of claim 9, further comprising:
a video-in module in the first location for receiving the first video signals.

11. The system of claim 9, further comprising:
a video processing module for processing the first video signals to generate a first view and processing the second video signals to generate a second view, the first view comprising substantial life-size images of participants in the first group, the second view comprising substantial life-size images of participants in the second group;
wherein the video-out module in the second location is configured to display the first view; and
wherein the video-out module in the first location is configured to display the second view.

12. The system of claim 9, further comprising:
an audio-in module for receiving audio signals from the first group;
wherein the control module identifies the target participant from the first group based on the audio signals.

13. The system of claim 9, further comprising:
a video processing module for processing the first video signals to generate a first view and processing the second video signals to generate a second view, the first and second views being substantially free from foreshortening and parallax effects;
wherein the video-out module in the second location is configured to display the first view; and
wherein the video-out module in the first location is configured to display the second view.

14. A teleconference system for establishing a teleconference between a first group of participants in a first location and a second group of participants in a second location, the system comprising:
a video-out module for displaying first video signals of the first group to the second group, the first video signals comprising a video display of the eyes of the participants in the first group;
a control module for identifying a target participant from the first group, the target participant changes during the teleconference;
a video-in module for receiving second video signals of the second group, the second video signals being received at a position proximate to the position of the video display of the eyes of the target participant as being displayed to the second group by the video-out module, the second video signals comprising a video display of the eyes of the participants in the second group; and
a video process module for processing the second video signals.

15. The system of claim 14, wherein the video process module processes the second video signals to substantially remove foreshortening and parallax effects.

16. A teleconference system for establishing a teleconference between a first group of participants and a second group of participants, the system comprising:
a video-in module for receiving first video signals of the first group;
a video process module for processing the first video signals to generate a first view comprising images of participants in the first group, wherein the first view is substantially free from foreshortening and parallax effects, wherein the processing includes one or more of: resizing, repositioning, and rotating the first video signals; and
a video-out module for displaying first video signals of the first group to the second group.

17. The system of claim 16, wherein the first view comprising substantially life-size images of participants in the first group.
